(19) United States
(12) Patent Application Publication
(10) Pub. No.: US 2016/0261032 A1
(43) Pub. Date: Sep. 8, 2016

(54) WEARABLE ELECTRONIC DEVICE

(71) Applicant: Acer Incorporated, New Taipei City (TW)

(72) Inventors: Yu-Chia Chang, New Taipei City (TW); Hsieh-Chih Lin, New Taipei City (TW); Pei-Yuan Chiu, New Taipei City (TW); Hsien-Chang Lin, New Taipei City (TW)

(21) Appl. No.: 14/700,151

(22) Filed: Apr. 30, 2015

(30) Foreign Application Priority Data
Mar. 5, 2015 (TW) 104107011

(51) Int. Cl. H01Q 1/27; G06F 3/041

(52) U.S. Cl. CPC H01Q 1/273; G06F 3/0412

(57) ABSTRACT

A wearable electronic device including a metal ring-shaped frame, a conductive film, a grounding element and a signal element is provided. The conductive film is arranged in the metal ring-shaped frame, and the conductive film and the metal ring-shaped frame are spaced apart by a predetermined gap to constitute a resonant cavity. The grounding element is arranged in the metal ring-shaped frame and coupled with the metal ring-shaped frame and the conductive film. The signal element is arranged in the metal ring-shaped frame and coupled between the metal ring-shaped frame and a circuit board. The signal element and grounding element constitute a closed resonant cavity with a specific length therebetween for serving as an antenna of the wearable electronic device.

### CROSS-REFERENCE TO RELATED APPLICATION

This application claims the priority benefit of Taiwan application serial no. 104107011, filed on Mar. 5, 2015. The entirety of the above-mentioned patent application is hereby incorporated by reference herein and made a part of this specification.

### BACKGROUND OF THE INVENTION

1. Field of the Invention

The invention relates to an electronic device, and relates particularly to a wearable electronic device.

2. Description of Related Art

In recent years, along with advances of miniaturization in industrial technology and a rise in health awareness, a wearable electronic device such as a smart watch has been developed gradually and the technology is maturing. A design of a wearable electronic device requires consideration in two fields: portable convenience and product appearance similar to a traditional watch. In other words, in the pursuit of portable convenience (design towards small and thin dimensional) of the wearable electronic device, in order to increase a user's willingness to use and acceptance for the wearable electronic device, the appearance of the wearable electronic device preferably is similar to that of a traditional watch. As such, it is preferable for the wearable electronic device to have an all metallic external appearance, namely adopting a metallic material for the frame. In addition, adopting a metallic material for the frame also aids in increasing the mechanical strength of the wearable electronic device.

However, when the wearable electronic device is arranged with an antenna used for transmitting or receiving a wireless signal, a metal material frame will act as a shield to a wireless signal of the antenna and is not advantageous for obtaining good antenna radiation efficiency and causes the signal receiving results of the wearable electronic device to degrade. However, if a plastic material is adopted for the frame in order for improving the situation of the shielded signal, then it is difficult for the external appearance of the wearable electronic device to be similar to that of a traditional watch and may significantly decrease the user's willingness to use and acceptance. And, at the same time, the mechanical strength of the wearable electronic device is decreased. In this way, how to adopt a metal material for the frame of a wearable electronic device and still maintain good antenna radiation efficiency for providing a user with good signal receiving results has become a focus for designers.

### SUMMARY OF THE INVENTION

The invention provides a wearable electronic device, having a metallic appearance and good antenna radiation efficiency.

The wear wearable electronic device of the invention includes a metal ring-shaped frame, a conductive film, a grounding element and a signal element. The conductive film is arranged in the metal ring-shaped frame, and the conductive film and the metal ring-shaped frame are spaced apart by a predetermined gap to constitute a resonance cavity. The grounding element is arranged in the metal ring-shaped frame, and coupled to the metal ring-shaped frame and the conductive film. The signal element is arranged in the metal ring-shaped frame, and is coupled to the metal ring-shaped frame and a circuit board. The grounding element and the signal element constitute a closed resonant cavity with a specific length therebetween for serving as an antenna through the closed resonance cavity.

Based on the above, the wearable electronic device of the invention adopts a metal ring-shaped frame providing a metal appearance, and is arranged with a conductive film, a grounding element and a signal element, wherein the conductive film and the metal ring-shaped frame are spaced apart by a predetermined gap to make the predetermined gap to constitute a resonance cavity, and the grounding element is coupled to the metal ring-shaped frame and the conductive film. And, the signal element is coupled to the metal ring-shaped frame, and forms a closed resonance cavity with a specific length therebetween with the grounding element for serving as an antenna through the resonance cavity. As may be seen, the wearable electronic device of the invention adopts a metal appearance, and adopts the signal element, the grounding element and the resonance cavity to serve as the antenna and radiate a wireless signal, to solve the situation where metal appearance shields the antenna radiation. In this way, the wearable electronic device of the invention has a metal appearance and good antenna radiation efficiency.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded schematic diagram of a wearable electronic device according to an embodiment of the invention.

FIG. 2 is a cross-sectional schematic diagram of the wearable electronic device of FIG. 1.

FIG. 3 is another cross-sectional schematic diagram of the wearable electronic device of FIG. 1.

FIG. 4 is a schematic plan diagram of the wearable electronic device of FIG. 1.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

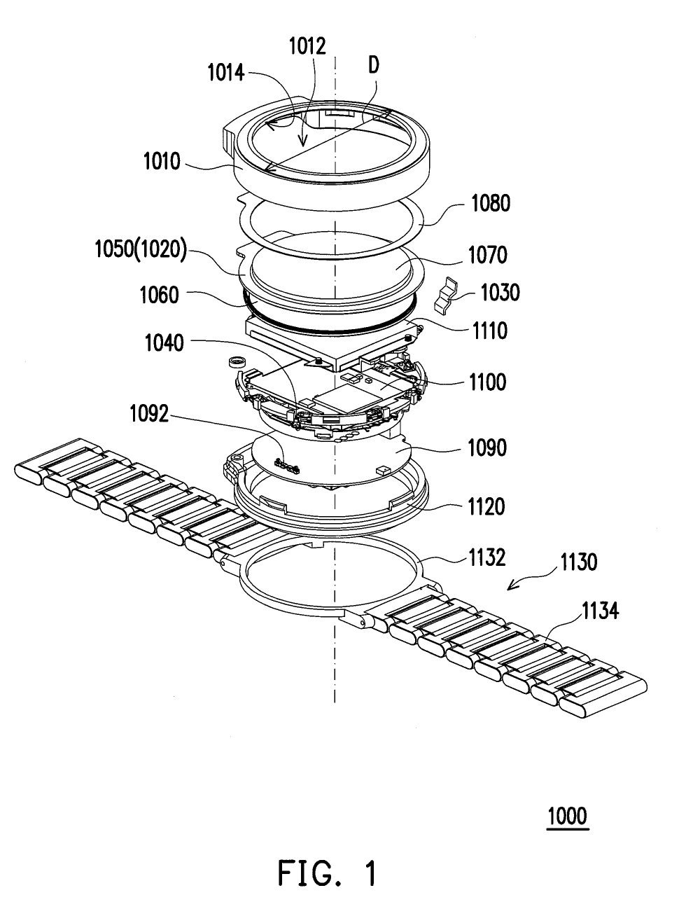

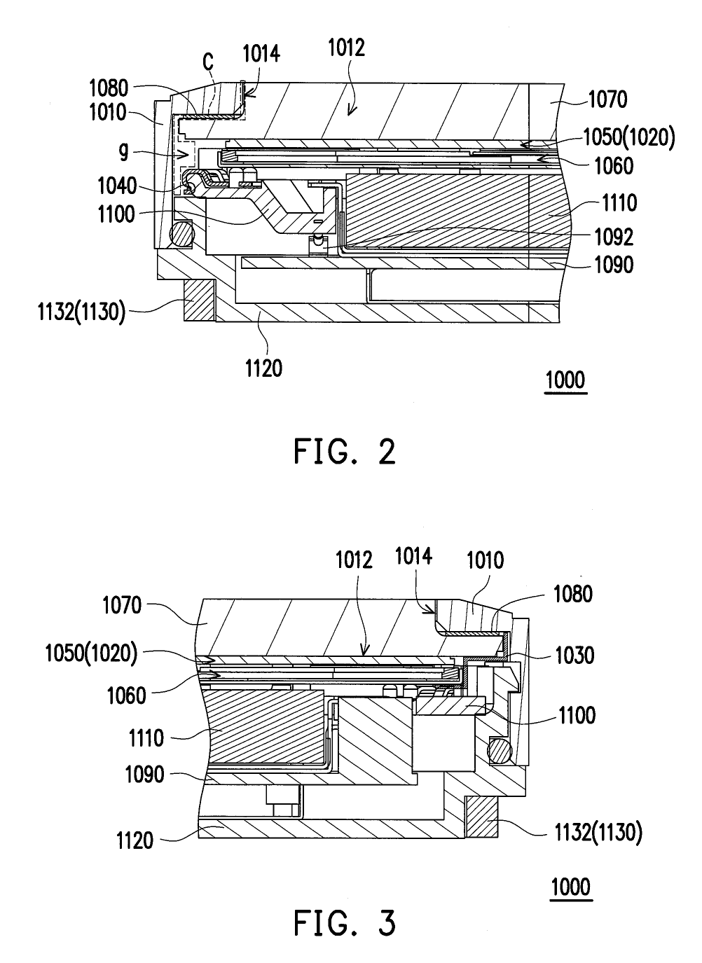

FIG. 1 is an exploded schematic diagram of a wearable electronic device according to an embodiment of the invention. In the present embodiment, a wearable electronic device 1000, for example, is a smart watch or other suitable electronic device which may be worn on a body of a user, for example, worn on the wrist of a user; however the type of the wearable electronic device 1000 should not be construed as a limitation to the invention. The wearable electronic device 1000 includes a metal ring-shaped frame 1010, a conductive film 1020, a grounding element 1030 and a signal element 1040. The conductive film 1020 is arranged in the metal ring-shaped frame 1010, and the conductive film 1020 and the metal ring-shaped frame 1010 are spaced apart by a predetermined gap g to constitute a resonant cavity C (the gap g and the resonant cavity C are shown in FIG. 2). The grounding element 1030 is arranged in the metal ring-shaped frame 1010, and is coupled to the metal ring-shaped frame 1010 and the conductive film 1020. The signal element 1040 is arranged in the metal ring-shaped frame 1010 and is coupled to the metal ring-shaped frame 1010, and the signal element 1040 and the grounding element 1030 constitute the closed resonant cavity C with a specific length therebetween for serving as an antenna through the resonant cavity C. In this way, the wearable electronic device 1000 has a metallic appearance and has antenna functionality. Furthermore, the antenna functionality will not be shielded by the metal exterior and affect the antenna radiation efficiency thereof.

More specifically, in the present embodiment, a material of the metal ring-shaped frame 1010 includes stainless steel or aluminium and is rendered circular. The diameter D thereof is between 37 millimeters to 50 millimeters, however the material, shape and dimensions thereof should not be construed as a limitation to the invention and may be selected according to requirements. Furthermore, the metal ring-shaped frame 1010 is a metallic ring-shaped cover, and has an internal space 1012 and an opening 1014. Most of the components (for example, the conductive film 1020, the grounding element 1030 and the signal element 1040) of the wearable electronic device 1000 are arranged in the internal space 1012 of the metal ring-shaped frame 1010, and a portion of the components (for example, a transparent cover plate mentioned later) may be exposed from the opening 1014 of the metal ring-shaped frame 1010. The metal ring-shaped frame 1010 is the outermost component of the wearable electronic device 1000 and is an entirely metal structure, namely the metal ring-shaped frame 1010 is formed without a seam structure of plastic material. In this way, the metal ring-shaped frame 1010 may provide the wearable electronic device 1000 to have a metallic appearance and good structural strength.

Furthermore, in the present embodiment, the wearable electronic device 1000 further includes a touch panel 1050 arranged inside the metal ring-shaped frame 1010 to act as an input interface. Here, a touch film in the touch panel 1050 may act as the aforementioned conductive film 1020. Furthermore, because the wearable electronic device 1000 may arrange the touch panel 1050 to act as the input interface according to needs, typically a touch film is arranged in the interior of the touch panel 1050, for example, using indium tin oxide (ITO) or other conductive material as a touch conductive pattern of the transparent film. In this situation, the touch film inside the touch panel 1050 may act as the aforementioned conductive film 1020 and another additional conductive film different from the touch film is not required to be adopted. In other words, the present embodiment uses the touch panel 1050 as a method for arranging the conductive film 1020. However, the arrangement or not of the touch panel 1050 should not be construed as a limitation to the invention. In other embodiments without having the touch panel 1050 arranged, the conductive film 1020 may be a transparent film arranged with conductive material, and the method for implementing the conductive film 1020 of the invention should not be limited thereto.

In addition, in the present embodiment, the grounding element 1030, for example, is conductive tape, conductive copper foil, metal sheet or FPC coupled to the metal ring-shaped frame 1010 and the conductive film 1020 such that the closed resonance cavity C with a particular length L is formed between the signal element 1040 and the grounding element 1030. In other words, the closed resonance cavity C of the particular length L corresponds to the regions between the grounding element 1030, the metal ring-shaped frame 1010, the conductive film 1020 and the signal element 1040. More specifically, the grounding element 1030 is actually coupled to the metal ring-shaped frame 1010 and the touch panel 1050, a specific method, for example, is by attaching the conductive tape, conductive copper foil, metal sheet or FPC to the metal ring-shaped frame 1010 and the touch panel 1050, as shown in FIG. 3. In this way, a closed spot is formed in the predetermined gap g between the metal ring-shaped frame 1010 and the conductive film 1020 to act as a grounding point, such that the resonant cavity C constituted by the predetermined gap g has a specific length L between the signal element 1040 and the grounding element 1030. In other words, the conductive film 1020 and the metal ring-shaped frame 1010 are spaced apart by a predetermined gap g to constitute the resonant cavity C, and the signal element 1040 and the grounding element 1030 act as closed spots at two ends of the resonant cavity C, such that the resonant cavity C becomes a closed resonance cavity C with a specific length. However, the method for implementing the grounding element 1030 of the invention is not limited thereto and may be selected according to requirements.

On the other hand, in the present embodiment, the wearable electronic device 1000 may be arranged with a display panel 1060 to act as an output interface according to requirements. The display panel 1060 is arranged in the metal ring-shaped frame 1010 and is stacked together with the touch panel 1050. In this way, the predetermined gap g between the touch panel 1050 (providing the conductive film 1020) and the metal ring-shaped frame 1010 further extends to between the display panel 1060 and the metal ring-shaped frame 1010. The grounding element 1030 is actually coupled to the metal ring-shaped frame 1010, the touch panel 1050 and the display panel 1060, such that the resonant cavity C constituted by the predetermined gap g constitutes the specific length L between the signal element 1040 and the grounding element 1030, and the specific length L of the resonant cavity C corresponds to the regions between the grounding element 1030, the metal ring-shaped frame 1010, the touch panel 1050, the display panel 1060 and the signal element 1040. The display panel has a driver FPC to receive display data, and this driver FPC also can be used as grounding element 1030. However, the arrangement or not of the display panel 1060 should not be construed as a limitation to the invention and may be adjusted according to requirements.

Similarly, in the present embodiment, the wearable electronic device 1000 may be arranged with a transparent cover plate 1070 to provide a protection function according to requirements. The transparent cover plate 1070, for example, is a glass cover plate or other suitable transparent plate material, and arranged in the metal ring-shaped frame 1010, for example, by attaching in the metal ring-shaped frame 1010 through a double sided adhesive material 1080, and covering the touch panel 1050 that provides the conductive film 1020. In other words, the transparent cover plate 1070, the touch panel 1050 and the display panel 1060 are stacked together sequentially. In this way, the predetermined gap g between the touch panel 1050 (providing the conductive film 1020) and the metal ring-shaped frame 1010 further extends to between the transparent cover plate 1070 and the metal ring-shaped frame 1010, such that the predetermined gap g extending to between the transparent cover plate 1070 and the metal ring-shaped frame 1010 constitute the resonance cavity C, and the resonance cavity C corresponds to the regions between the grounding element 1030, the signal element 1040, the metal ring-shaped frame 1010, the touch panel 1050 and the transparent cover plate 1070. In addition, the transparent cover plate 1070 is arranged between the metal ring-shaped frame 1010 and the other components (for example, the touch panel 1050 and the display panel 1060) disposed in the metal ring-shaped frame 1010, and may be exposed from the opening 1014 of the metal ring-shaped frame 1010, to act as an operation surface of the wearable electronic device 1000. Preferably, the transparent cover plate 1070 has high hardness and scratch resistant characteristics to provide a protection function. However, the method of arrangement and the arrangement or not of the transparent cover plate 1070 should not be construed as a limitation to the invention and may be adjusted according to requirements.

Furthermore, in the present embodiment, the wearable electronic device 1000 further includes a circuit board 1090, a fixed frame 1100 and a battery 1110. The circuit board 1090, for example, is a printed circuit board (PCB) or other suitable circuit board arranged in the metal ring-shaped frame 1010, and is arranged with a wireless communication element not shown coupled to a metal connector 1092 located on the printed circuit board that is serving as the circuit board 1090, and used to transmit or receive wireless signals. Here, the metal ring-shaped frame 1010 is coupled to the circuit board 1090 by the signal element 1040 and the metal connector 1092, for serving as the antenna through the resonant cavity C and transmits or receives the wireless signal. In other words, the signal element 1040 is coupled to the metal ring-shaped frame 1010 and the circuit board 1090. In addition, the fixed frame 1100 is arranged in the metal ring-shaped frame 1010 and has a conductive patter not shown. The signal element 1040 and the metal connector 1092 are coupled to the conductive pattern to constitute the signal feed-in point of the antenna. The battery 1110 is arranged in the metal ring-shaped frame 1010, and is located at a side of the circuit board 1090, for serving as the power source of the wearable electronic device 1000 and providing power to the circuit board 1090, the touch panel 1050, the display panel 1060 and such components.

More specifically, in the present embodiment, the fixed frame 1100 is constituted by a plastic material and a metal material. Furthermore, the fixed frame 1100 is generally a plastic element and arranged with metal material (a metal piece, for example), for example, adopting laser direct structuring (LDS) technology to constitute the conductive pattern on the plastic element. In this way, the fixed frame 1100 may be used to fix the circuit board 1090, the battery 1110 and such components (for example, fixing the circuit board 1090 and the battery 1110 at two sides of the fixed frame 1100) and may also have an antenna function. More specifically, in the present embodiment, the signal element 1040, for example is a metal spring arranged on the fixed frame 1100 and coupled to the aforementioned conductive pattern, and the signal element 1040 is further couple to the circuit board 1090 through the aforementioned conductive pattern contacting the metal connector 1092. In this way, the fixed frame 1100 may constitute the signal feed-in point of the antenna by the laser direct structuring technology in collocation with the metal spring serving as the signal element 1040, and the signal element 1040 and the fixed frame 1100 constituting the signal feed-in point are coupled to the wireless communication element not shown of the circuit board 1090 and the metal ring-shaped frame 1010 by coupled the metal connector 1092 (for example, the metal spring serving as the signal element 1040 coupled an inner wall of the metal ring-shaped frame 1010).

In this way, a wireless signal produced by the wireless communication element not shown may feed in to the resonance cavity C located between the metal ring-shaped frame 1010, the touch panel 1050 (providing the conductive film 1020) and the grounding element 1030 through the metal connector 1092 coupled the fixed frame 1100 and the signal element 1040 serving as the signal feed-in point, and transmit the wireless signal out of the wearable electronic device 1000 through the resonance cavity C acting as the antenna. Opposite to this, the aforementioned resonance cavity C serving as the antenna also may receive a wireless signal outside of the wearable electronic device 1000, and transmit to the wireless communication element not shown through the fixed frame 1100, the signal element 1040 and the metal connector 1092 acting as the signal feed in point. In this way, the wearable electronic device 1000 has an antenna function, and may transmit or receive a wireless signal. In addition, because the present embodiment adopts the signal element 1040 and the resonance cavity C to serve as the antenna and radiate the wireless signal, therefore the wearable electronic device 1000 will not affect the antenna radiation efficiency thereof due to metal shielding.

Furthermore, in order to secure the above mentioned components, the wearable electronic device 1000 of the present embodiment further includes a base 1120. The base 1120 is assembled to the metal ring-shaped frame 1010, and the grounding element 1030, the signal element 1040, the touch panel 1050 (providing the conductive film 1020), the display panel 1060, the transparent cover plate 1070, the circuit board 1090, the fixed frame 1100, the battery 1110 and such components are located between the base 1120 and the metal ring-shaped frame 1010. In other words, the base 1120 and the metal ring-shaped frame 1010 are the outermost components of the wearable electronic device 1000, and are assembled together and house the above mentioned components therein. In this way, because the metal ring-shaped frame 1010 adopts a metal material, preferably a metal material is also adopted for the base 1120, such that the wearable electronic device 1000 has an overall matching metal appearance, however the material of the base 1120 should not be construed as a limitation to the invention and may be adjusted according to requirements.

In addition, in order to make it easier for the wearable electronic device 1000 of the present embodiment to be worn on the body of the user, the wearable electronic device 1000 further includes a wearing element 1130. In the present embodiment, the wearing element 1130 includes a circular watch base 1132 and two watch straps 1134. A contour of the circular watch base 1132 fits with a contour of the base 1120 and a contour of the metal ring-shaped frame 1010, for further being assembled at the outside of the base 1120 and the metal ring-shaped frame 1010 (for example, sleeved onto the base 1120). Similarly, preferably metal material is also adopted for the circular watch base 1132 such that the wearable electronic device 1000 has an overall matching metal appearance, however it should not be construed as a limitation to the invention. The watch straps 1134 are arranged at two opposite sides of the circular watch base 1132, therefore the wearable electronic device 1000 may be worn on the wrist of the user by the watch straps 1134. In this way, the wearable electronic device 1000 may be a smart watch, generally rendered to an appearance of the traditional watch. Furthermore, the wearing element 1130 (including the circular watch base 1132 and the watch straps 1134) of the present embodiment may be detached from the base 1120 and the metal ring-shaped frame 1010, therefore the user also may change the type of wearing element 1130 (for example, a watch strap having different color) according to needs. However, in other embodiments, the wearing element adopted by the wearable electronic device may be a watch strap arranged on the base and the use of the circular watch base may be omitted. Also, the wearing element does not necessarily have to be used to render a general appearance of a traditional pocket watch, and the method of implementation and the arrangement or not of the wearing element of the invention is not limited thereto and may be adjusted according to requirements.

FIG. 2 is a cross-sectional schematic diagram of the wearable electronic device of FIG. 1. FIG. 3 is another cross-sectional schematic diagram of the wearable electronic device of FIG. 1. Please referring FIGS. 1-3, in the present embodiment, the conductive film 1020 and the metal ring-shaped frame 1010 are spaced apart by the predetermined gap g to constitute the resonant cavity C (shown in FIG. 2), the grounding element 1030 is coupled to the metal ring-shaped frame 1010 and the conductive film 1020 (shown in FIG. 3), and the signal element 1040 is coupled to the metal ring-shaped frame 1010 (shown in FIG. 2), such that the closed resonance cavity C with a particular length L is formed between the signal element 1040 and the grounding element 1030. In other words, a closed spot is formed in the predetermined gap g to serve as the resonance cavity C, and the signal element 1040 and the grounding element 1030 act as closed spots at two ends of the resonant cavity C, such that the resonant cavity C becomes a closed resonance cavity C with the specific length L, and the closed resonance cavity C corresponds to the regions between the grounding element 1030, the metal ring-shaped frame 1010, the conductive film 1020 and the signal element 1040. As such, the specific length L is determined by the positions of the grounding element 1030 and signal element 1040 (or relative distance therebetween), wherein the positions of the grounding element 1030 and signal element 1040 in this embodiment are located at two opposite sides of the metal ring-shaped frame 1010 (as shown in FIGS. 1-3), which may be adjusted according to needed and should not be limited thereto.

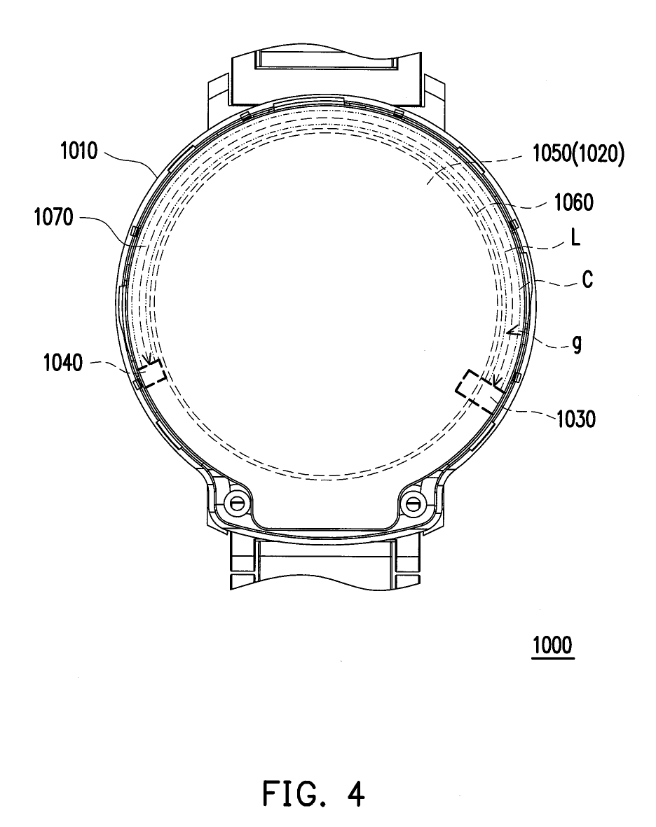

FIG. 4 is a schematic plan diagram of the wearable electronic device of FIG. 1. Wherein, the dotted line of FIG. 4 illustrates the components (for example, the grounding element 1030 and the signal element 1040) located in the metal ring-shaped frame 1010, and omits partial components (for example, the circuit board 1090 and the fixed frame 1100). Referring to FIG. 1 to FIG. 4, in the present embodiment, the grounding element 1030 is coupled to the metal ring-shaped frame 1010 and the touch panel 1050 (providing the conductive film 1020), and is further coupled to the display panel 1060 and the transparent cover plate 1070, such that the predetermined gap g between the metal ring-shaped frame 1010, the touch panel 1050, the display panel 1060 and the transparent cover plate 1070 constitute the resonance cavity C. The signal element 1040 is coupled to the circuit board 1090, the fixed frame 1100 and the metal ring-shaped frame 1010, to serve as the antenna through the resonance cavity C and transmit or receive the wireless signal. Details pertaining to the aforementioned content will not be repeated here. In this way, the resonance cavity C constituted by the signal element 1040 and the grounding element 1030 is generally an elongated space, and the length L (labelled in FIG. 4) of the resonance cavity C will influence the operating frequency of the wireless signal transmitted or received when the resonance cavity C serving as an antenna.

In the present embodiment, the length L of the resonance cavity C constituted by the signal element 1040 and the grounding element 1030 is between 0.5 times to 0.7 times the wavelength of the operating frequency of the antenna. Preferably, the length L of the resonance cavity C is 0.64 times the wavelength of the operating frequency of the antenna. In this range, the relative distance (namely the length L of the resonance cavity C) between the signal element 1040 and the grounding element 1030 may be adjusted. For example, adopting a length L of the resonance cavity C that is 0.64 times the wavelength of the operating frequency of the antenna, suppose the antenna design of the wearable electronic device 1000 requires a wireless signal with a transmitting or receiving operating frequency of 2.4 gigahertz (GHz), if it is desired to arrange the resonance cavity C fitting the aforementioned required operating frequency on the wearable electronic device 1000, due to the wavelength of the above mentioned operating frequency is 12.5 centimeters (cm), therefore the length L of the resonance cavity C is required to be 0.64 times the wavelength (12.5 centimeters) of the operating frequency (2.4 gigahertz) of the antenna, namely 8 centimeters. In this way, in the present embodiment, the relative distance (namely the length L of the resonance cavity C) between the signal element 1040 and the grounding element 1030 is 8 centimeters. It may be seen, the wearable electronic device 1000 of the present embodiment not only has an antenna function, the length L of the resonance cavity C (namely the relative distance between the signal element 1040 and the grounding element 1030) may be adjusted according to the operating frequency of the wireless signal desired to transmit or receive, such that the wearable electronic device 1000 may be applicable to wireless communication requirements of various operating frequencies.

In summary, the wearable electronic device of the invention adopts a metal ring-shaped frame providing a metal appearance, and is arranged with a touch panel (providing a conductive film), a grounding element and a signal element, wherein the conductive film and the metal ring-shaped frame are spaced apart by a predetermined gap to make the predetermined gap to constitute a resonance cavity, and the grounding element is coupled to the metal ring-shaped frame and the conductive film. In addition, the signal element is coupled to the metal ring-shaped frame, and forms a closed resonance cavity with a specific length therebetween with the grounding element, wherein the signal element uses the metal connector on the circuit board coupled to the wireless communication element and the conductive pattern on the fixed frame to act as a signal feed-in point, and then transmit or receive a wireless signal through the resonance cavity serving as an antenna. As may be seen, the wearable electronic device of the invention adopts a metal appearance, and adopts the signal element and the resonance cavity to serve as the antenna and radiate a wireless signal, to solve the situation where metal appearance shields the antenna radiation. In this way, the wearable electronic device of the invention has a metal appearance and good antenna radiation efficiency.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wearable electronic device comprising:
a metal ring-shaped frame;
a conductive film, arranged in the metal ring-shaped frame, the conductive film and the metal ring-shaped frame are spaced apart by a predetermined gap to constitute a resonance cavity;
a grounding element, arranged in the metal ring-shaped frame, and coupled to the metal ring-shaped frame and the conductive film; and
a signal element, arranged in the metal ring-shaped frame, and coupled to the metal ring-shaped frame and a circuit board, the grounding element and the signal element constitute a closed resonant cavity with a specific length therebetween for serving as an antenna through the closed resonance cavity.

2. The wearable electronic device as claimed in claim 1, further comprising:
a touch panel, arranged in the metal ring-shaped frame, wherein the conductive film is a touch film of the touch panel, and the grounding element is coupled to the metal ring-shaped frame and the touch panel.

3. The wearable electronic device as claimed in claim 2, further comprising:
a display panel, arranged in the metal ring-shaped frame, and located on a side of the touch panel, the grounding element is coupled to the metal ring-shaped frame, the touch panel and the display panel.

4. The wearable electronic device as claimed in claim 1, wherein the circuit board is arranged in the metal ring-shaped frame, and is arranged with a wireless communication element used to transmit or receive a wireless signal, the signal element is coupled to the circuit board and the metal ring-shaped frame.

5. The wearable electronic device as claimed in claim 1, further comprising:
a fixed frame, arranged in the metal ring-shaped frame, and having a conductive pattern, the signal element is coupled to the conductive pattern to constitute a signal feed-in point of the antenna.

6. The wearable electronic device as claimed in claim 1, further comprising:
a transparent cover plate, arranged in the metal ring-shaped frame, and covering the conductive film, the grounding element is coupled to the metal ring-shaped frame, the conductive film and the transparent cover plate.

7. The wearable electronic device as claimed in claim 1, further comprising:
a base, assembled to the metal ring-shaped frame, and the conductive film, the grounding element and the signal element are located between the base and the metal ring-shaped frame.

8. The wearable electronic device as claimed in claim 1, wherein a length of the resonance cavity constituted by the signal element and the grounding element is between 0.5 times to 0.7 times of a wavelength of an operating frequency of the antenna.

9. The wearable electronic device as claimed in claim 1, wherein a material of the metal ring-shaped frame comprises stainless steel or aluminium.

10. The wearable electronic device as claimed in claim 1, wherein the metal ring-shaped frame is rendered circular, and a diameter thereof is between 37 millimeters to 50 millimeters.
